(19) United States
(12) Patent Application Publication
(10) Pub. No.: US 2012/0235377 A1
(43) Pub. Date: Sep. 20, 2012

(54) HANDCYCLE AND DRIVE MECHANISM THEREFORE

(76) Inventors: David Bailey, Murrieta, CA (US); Kirk Hoepnner, Granite Falls, WA (US)

(21) Appl. No.: 13/108,486

(22) Filed: May 16, 2011

Related U.S. Application Data
(60) Provisional application No. 61/454,533, filed on Mar. 19, 2011.

(51) Int. Cl. B62M 1/14; B62M 9/00

(52) U.S. Cl. 280/250; 474/148

(57) ABSTRACT

A drive mechanism for a handcycle has a master drive sprocket rotatably mounted on a frame adjacent a front wheel of the handcycle, and positioned away from a driver seating area. The drive mechanism further includes a drive chain operably connected to the master drive sprocket and adapted to operably engage the front wheel. An elongate extension element extends from the frame adjacent the front wheel towards the driver seating area. A pair of hand cranks are rotatably connected to a pivot element of the elongate extension element, each of the pair of hand cranks terminating in a hand grip. A transmission operably connects the pair of hand cranks with the master drive sprocket, such that rotation of the pair of hand cranks turns the master drive sprocket for driving the front wheel.

### CROSS-REFERENCE TO RELATED APPLICATIONS

This application for a utility patent claims the benefit of U.S. Provisional Application No. 61/454,533, filed Mar. 19, 2011.

### BACKGROUND OF THE INVENTION

1. Field of the Invention

This invention relates generally to handcycles, and more particularly to a drive mechanism for a handcycle.

2. Description of Related Art

There are various handcycles known in the art that include hand cranks for driving the handcycle. One example of such a handcycle is illustrated in Franks et al., U.S. Pat. No. 6,105,986, which is hereby incorporated by reference in full. The Franks handcycle includes a hand drive mechanism that includes a main sprocket that is driven by a pair of hand cranks, and a chain that operably connects the main drive sprocket with a wheel sprocket of a front wheel.

The problem with this design is that the main drive sprocket is awkwardly positioned in the face of the user. Not only is it a dirty and greasy nuisance, and an obstruction to the user when mounting the handcycle, it is also a potential safety hazard in the event of a crash.

### SUMMARY OF THE INVENTION

The present invention teaches certain benefits in construction and use which give rise to the objectives described below.

The present invention provides a drive mechanism for a handcycle. The drive mechanism comprises a master drive sprocket rotatably mounted on a frame adjacent a front wheel of the handcycle, and positioned away from a driver seating area. The drive mechanism further includes a drive chain operably connected to the master drive sprocket and adapted to operably engage the front wheel. An elongate extension element extends from the frame adjacent the front wheel towards the driver seating area. A pair of hand cranks are rotatably connected to a pivot element of the elongate extension element, each of the pair of hand cranks terminating in a hand grip. A transmission operably connects the pair of hand cranks with the master drive sprocket, such that rotation of the pair of hand cranks turns the master drive sprocket for driving the front wheel.

A primary objective of the present invention is to provide a drive mechanism for a handcycle, the drive mechanism having advantages not taught by the prior art.

Another objective is to provide a drive mechanism for a handcycle that includes a main drive sprocket that is positioned away from the driver.

A further objective is to provide a handcycle that is easier to mount and dismount, and that is safer in the event of a crash.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a left side elevational view of a handcycle according to one embodiment of the present invention, illustrating a drive mechanism for the handcycle;

FIG. 2 is a right side elevational view thereof;

FIG. 3 is a side elevational view of a prior art handcycle, illustrating a master drive sprocket extending towards the face and chest of the rider; and

FIG. 4 is an exploded perspective view of the drive mechanism of the handcycle of FIGS. 1-2.

### DETAILED DESCRIPTION OF THE INVENTION

The above-described drawing figures illustrate the invention, a drive mechanism 40 for a handcycle 10.

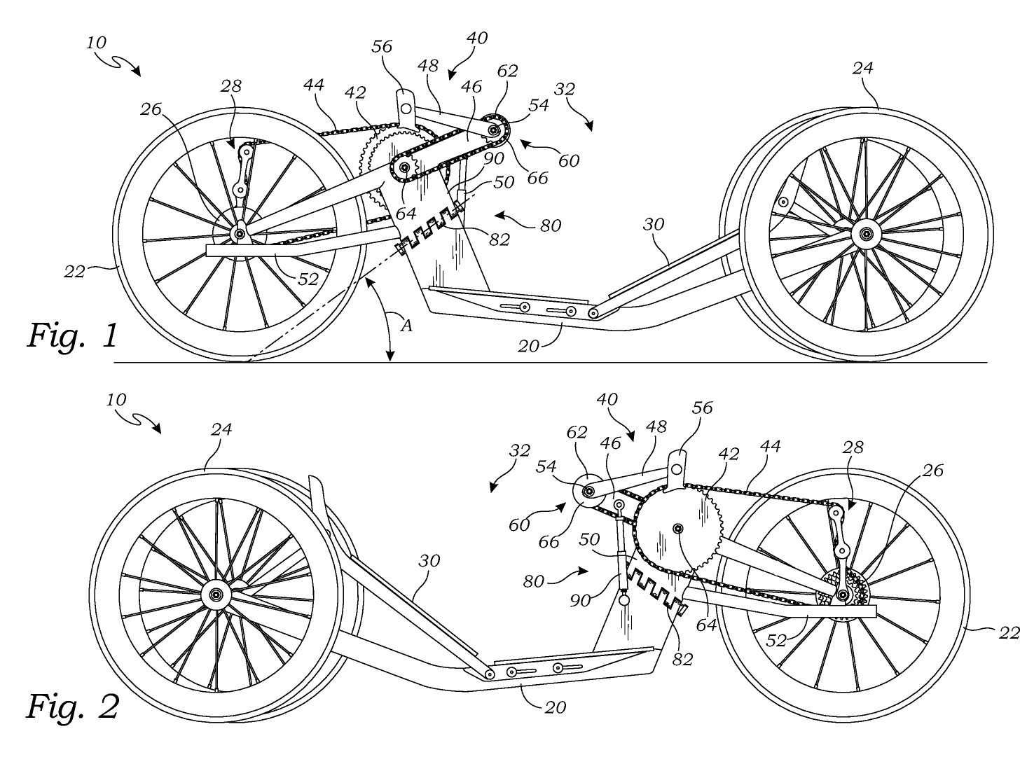

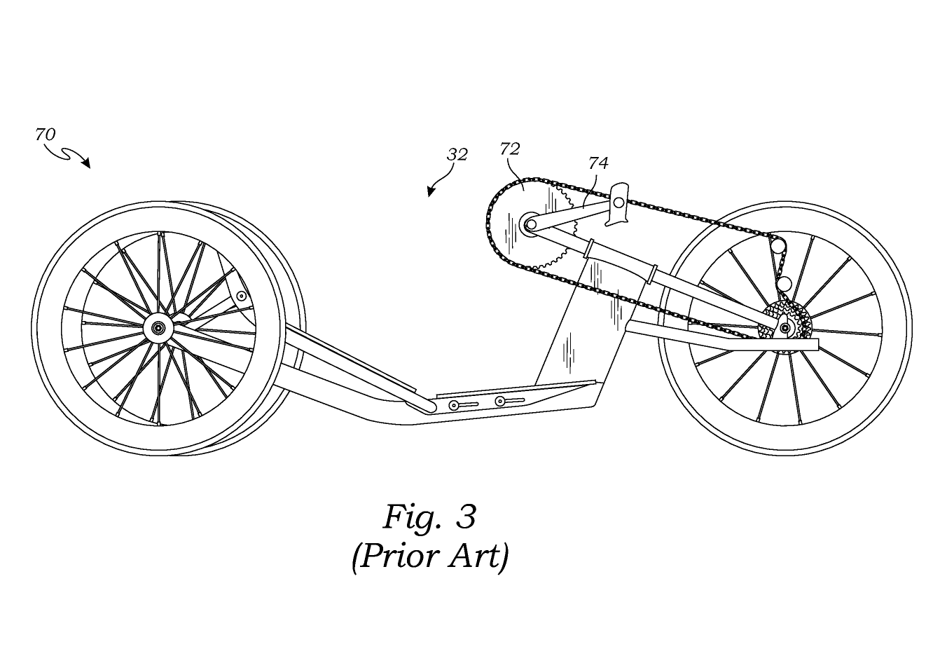

FIG. 1 is a left side elevational view of the handcycle 10 according to one embodiment of the present invention. FIG. 2 is a right side elevational view thereof. As illustrated in FIGS. 1-2, the handcycle 10 includes a frame 20 supported by front and rear wheels 22 and 24. In some embodiments, the frame 20 and the front and rear wheels 22 and 24 may be similar to prior art handcycles, and thus may vary considerably in construction. Typically the handcycle 10 includes a single front wheel 22 and two rear wheels 24, but this can vary if desired, and the terminology used herein is expressly defined to include alternative numbers of front and rear wheels 22 and 24, as well as alternative constructions of the frame 20.

As is well known in the art, a wheel sprocket 26 is operably connected to the front wheel 22. For purposes of this application, the term “wheel sprocket” is defined to include one or more sprockets, as is well known in the art. The front wheel 22 may further include a derailleur gearing 28 for enabling control over the gearing of the drive mechanism 40.

As illustrated in FIGS. 1-2, a seat 30 is supported by the frame 20 for supporting the driver. The seat 30 may be padded and may include a seatbelt (not shown) and any other elements helpful to the driver while driving the handcycle 10. The seat 30 provides a driver seating area 32 that the driver occupies while driving the handcycle 10.

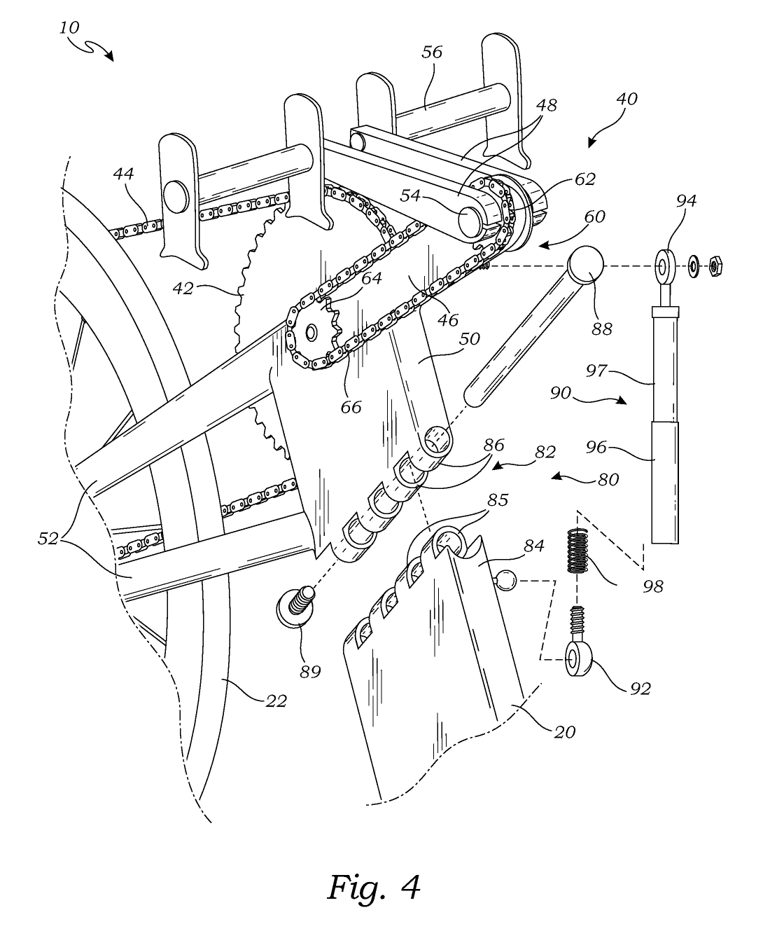

FIG. 4 is an exploded perspective view of the drive mechanism 40 of the handcycle 10 of FIGS. 1-2. As illustrated in FIGS. 1, 2, and 4, the drive mechanism 40 is operably mounted on the frame 20 for driving the front wheel 22. The drive mechanism 40 includes a master drive sprocket 42, a drive chain 44, an elongate extension element 46, a pair of hand cranks 48, and a transmission 60 for transferring the driving force from the pair of hand cranks 48 to the master drive sprocket 42. The elongate extension element 46 enables the driver to turn the master drive sprocket 42, as well as steer the handcycle 10, while maintaining a distance between the driver seating area 32 (and the driver) and the master drive sprocket 42. As discussed above, this space is more comfortable for the driver, and also helps prevent the driver from being injured by the master drive sprocket 42 in the event of a crash.

The master drive sprocket 42 is rotatably mounted on the frame 20 adjacent the front wheel 22 and positioned away from the driver seating area 32. As used in the present disclosure, the term “adjacent” should be broadly construed to include a general proximity, not necessarily abutting or immediately adjacent, and a position forward of the driver seating area 32 should be considered adjacent the front wheel 22. In one embodiment, the master drive sprocket 42 is mounted on a fork support structure 50 of the frame 20 that supports front forks 52 that support the front wheel 22.

The drive chain 44 is operably connected to the master drive sprocket 42 and operably engaged with the wheel sprocket 26 of the front wheel 22. The term “drive chain” is hereby defined to include any form of chain, linkage, or other form of equivalent transmission for operably connecting the master drive sprocket 42 and the wheel sprocket 26. Since such chains are generally known in the art, they are not described in greater detail herein.

The elongate extension element 46 extends from the frame 20 adjacent the front wheel 22, such as the fork support structure 50, towards the driver seating area 32. Those skilled in the art may devise many forms of devices or structures that provide this structure, and the term should be broadly construed, so long as the structure extends towards the driver seating area 32 in the necessary manner. Ideally, the elongate extension element 46 should extend to approximately the position of the prior art hand cranks 74, as illustrated in FIG. 3, within reach of the driver but not extending too close to the driver's chest.

As illustrated in FIGS. 1, 2, and 4, the pair of hand cranks 48 are rotatably connected to a pivot element 54 of the elongate extension element 46. Each of the pair of hand cranks 48 terminates in a hand grip 56 that is adapted to be easily gripped by the driver. The transmission 60 operably connects the pair of hand cranks 48 with the master drive sprocket 42, such that rotation of the pair of hand cranks 48 turns the master drive sprocket 42 and the wheel sprocket 26 for driving the front wheel 22. In the embodiment of FIGS. 1, 2, and 4, the transmission 60 is a hand crank sprocket 62, a second sprocket 64 operably attached to the master drive sprocket 42, and a transmission chain 66 operably connecting the hand crank sprocket 62 and the second sprocket 64. While this represents one embodiment, those skilled in the art may devise alternative transmissions 60, and such alternatives should be considered within the scope of the present invention.

FIG. 3 is a side elevational view of a prior art handcycle 70. In the prior art handcycle 70, a main sprocket 72 must be directly engaged with the prior art hand cranks 74, and this requires the main sprocket 72 to be positioned immediately adjacent the face and chest of the rider. Not only does this make it more difficult to get onto and off of the prior art handcycle 70, it is also unpleasant having the large and often dirty and greasy sprocket in this position, and it may also represent a safety concern in the event of a crash. This is avoided with the present invention, as is readily apparent in comparing the handcycle 10 of FIGS. 1-2 with the prior art handcycle 70 of FIG. 3.

As best illustrated in FIG. 4, the frame 20 includes a front frame body 84 in front of the seat 30, and a hinge 82 formed between the front frame body 84 and the fork support structure 50.

The front frame body 84 of this embodiment includes a first set of knuckles 85, and the fork support structure 50 includes a second set of knuckles 86, which may be interlocked and fastened with a pintle 88 to form the hinge 82. A locking element 89, such as a pin, screw, bolt, or other similar or equivalent element may be used to lock the pintle 88 in place, so that it does not inadvertently come out of the hinge 82 during use. The pintle 88 may, in one embodiment, be positioned at an angle A of between 25-70 degrees when operably positioned through the first and second sets of knuckles 85 and 86, or 30-60 degrees in another embodiment, or about 40 degrees in the present embodiment (+/−5 degrees). Not only does this hinge 82 provide a method of steering that provides excellent rigidity, it also enables the front wheel 22 to be readily removed from the frame, for transportation and storage of the handcycle 10.

In one embodiment, the handcycle 10 may further include an adjustable spring unit 90 that is connected to the frame 20 on each side of the hinge 82. In one embodiment, the adjustable spring unit 90 is attached to the front frame body 84 and to the fork support structure 50 (and/or the elongate extension element 46) such that the adjustable spring unit 90 extends across the hinge 82. In one embodiment, the adjustable spring unit 90 includes first and second elongate elements 96 and 97 that slidably engage one another, and a biasing element 98 (e.g., a spring, a pneumatic device, etc.) for biasing one of the elongate elements 96 or 97 towards a particular position or orientation with respect to the other.

The adjustable spring unit 90 may include a first pivot connection 92 for attaching the adjustable spring unit 90 to the front frame body 84, and a second pivot connection 94 for attaching the adjustable spring unit 90 to the fork support structure 50, so that the adjustable spring unit 90 may pivot with respect to the frame 20 and/or front wheel 22 when the handcycle 10 is being turned. The terms “first and second pivot connections” are hereby defined to include any combination of attachments, even if one does not pivot, as long as the combined connections enable steering of the handcycle 10 as described herein.

The adjustable spring unit 90 preferably biases the front wheel 22 towards a given direction of travel (typically straight), but allows the driver to steer by overcoming the bias of the adjustable spring unit 90. In one embodiment, the adjustable spring unit 90 may be readily adjusted to bias towards different directions if desired by the driver. The adjustable spring unit 90 is preferably readily removably to enables taking off the front wheel 22, as discussed above.

The terminology used in the specification provided above is hereby defined to include similar and/or equivalent terms, and/or alternative embodiments that would be considered obvious to one skilled in the art given the teachings of the present patent application. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one embodiment, it is to be clearly understood by those skilled in the art that the invention is not limited thereto. Rather, the scope of the invention is to be interpreted only in conjunction with the appended claims.

What is claimed is:

1-7. (canceled)

8. A handcycle, comprising:
a frame comprising:
a seat operably supported by rear wheels and forming a driver seating area;
a front frame body extending forward of the seat away from the rear wheels;
a fork support structure that includes forks for operably mounting a front wheel; and
a hinge pivotally connecting the front frame body and the fork support structure so that the front wheel can pivot with respect to the rear wheels;
a wheel sprocket operably connected to the front wheel;
a drive mechanism for driving the front wheel, the drive mechanism comprising:
a master drive sprocket rotatably mounted on the fork support structure above the hinge;
a drive chain operably connected to the master drive sprocket and the wheel sprocket of the front wheel;
an elongate extension element mounted on the fork support structure and extending towards the rear wheels beyond the hinge and into the driver seating area;
a pair of hand cranks rotatably connected to a pivot element of the elongate extension element, each of the pair of hand cranks terminating in a hand grip; and
a transmission operably connecting the pair of hand cranks with the master drive sprocket, such that rotation of the pair of hand cranks turns the master drive sprocket and the wheel sprocket for driving the front wheel, wherein the transmission comprises:
a hand crank sprocket operably engaged with the pair of hand cranks;
a second sprocket operably engaged with the master drive sprocket;
a transmission chain operably mounted on the hand crank sprocket and the second sprocket; and
wherein the hand crank sprocket has a smaller diameter than a diameter of the master drive sprocket.

9. The handcycle of claim 8, wherein the hinge comprises:
a first set of knuckles on the front frame body;
a second set of knuckles on the fork support structure; and
a pintle that is positioned through both the first and second sets of knuckles, wherein the pintle is positioned at an angle of about 40 degrees from horizontal.

10. The handcycle of claim 8, further comprising an adjustable spring unit that is attached to the front frame body with a first pivot connection, and to the fork support structure with a second pivot connection, the spring functioning to bias the front wheel towards a predetermined orientation with respect to the rear wheels.

11. A handcycle, comprising:
a frame comprising:
a seat operably supported by rear wheels and forming a driver seating area;
a front frame body extending forward of the seat away from the rear wheels;
a fork support structure that includes forks for operably mounting a front wheel; and
a hinge pivotally connecting the front frame body and the fork support structure so that the front wheel can pivot with respect to the rear wheels;
a wheel sprocket operably connected to the front wheel;
a drive mechanism for driving the front wheel, the drive mechanism comprising:
a master drive sprocket rotatably mounted on the fork support structure above the hinge;
a drive chain operably connected to the master drive sprocket and the wheel sprocket of the front wheel;
an elongate extension element mounted on the fork support structure and extending towards the rear wheels beyond the hinge and into the driver seating area;
a pair of hand cranks rotatably connected to a pivot element of the elongate extension element, each of the pair of hand cranks terminating in a hand grip; and
a transmission operably connecting the pair of hand cranks with the master drive sprocket, such that rotation of the pair of hand cranks turns the master drive sprocket and the wheel sprocket for driving the front wheel, wherein the transmission comprises:
a hand crank sprocket operably engaged with the pair of hand cranks;
a second sprocket operably engaged with the master drive sprocket;
a transmission chain operably mounted on the hand crank sprocket and the second sprocket; and
wherein the hand crank sprocket has a smaller diameter than a diameter of the master drive sprocket; and
an adjustable spring unit that is attached to the front frame body with a first pivot connection, and to the fork support structure with a second pivot connection, the spring functioning to bias the front wheel towards a predetermined orientation with respect to the rear wheels.
